(19) United States
(12) Patent Application Publication
(10) Pub. No.: US 2011/0223018 A1
(43) Pub. Date: Sep. 15, 2011

(54) Control System, Wind Farm, And Methods Of Optimizing The Operation Of A Wind Turbine

(76) Inventors: Prashant Srinivasan, Bangalore (IN); Philippe Giguere, Simpsonville, SC (US); Manish Gupta, Bangalore (IN); Rwitam Mitra, Maharashtra (IN)

(21) Appl. No.: 12/974,567

(22) Filed: Dec. 21, 2010

(51) Int. Cl. F03D 7/00

(52) U.S. Cl. 416/1; 416/31

(57) ABSTRACT

A control system for a wind turbine configured to generate an acoustic emission during operation includes a communication device. The communication device is configured to receive at least one penalty notification identifying a penalty to be assessed based on the acoustic emission generated. The control system also includes a processor coupled to the communication device. The processor is configured to calculate an acoustic emission level to be generated by the wind turbine based on the penalty and based on at least one of a power generated by the wind turbine and an economic value attributed to the wind turbine, and adjust at least one characteristic of the wind turbine to cause the wind turbine to operate at the calculated acoustic emission level.

### BACKGROUND OF THE INVENTION

The subject matter described herein relates generally to wind turbines and, more particularly, to a control system, a wind farm, and methods of optimizing the operation of a wind turbine.

Generally, a wind turbine includes a rotor that includes a rotatable hub assembly having multiple rotor blades. The rotor blades transform wind energy into a mechanical rotational torque that drives one or more generators by the rotor. The generators are sometimes, but not always, rotationally coupled to the rotor through a gearbox. The gearbox steps up the inherently low rotational speed of the rotor for the generator to efficiently convert the rotational mechanical energy to electrical energy, which is fed into a utility grid through at least one electrical connection. Gearless direct drive wind turbines also exist. The rotor, generator, gearbox and other components are typically mounted within a housing, or nacelle, positioned on top of a tower.

At least some known wind turbines are arranged in logical or geographical groups, known as wind farms. Moreover, at least some wind turbines within such wind farms generate acoustic emissions, or noise, during operation. Such acoustic emissions may be increased, for example, as a wind speed increases and/or as a rotational speed of the rotor increases. As each wind turbine within a wind farm operates, the combined acoustic emissions from the wind turbines may undesirably impact surrounding areas, such as population centers.

To account for the impact of such emissions, at least some known wind farms include at least one acoustic sensor. Generally, known acoustic sensors measure acoustic emissions and assess an economic penalty or another suitable penalty if the measured acoustic emissions exceed a threshold. Such penalties may be communicated to, and assessed against, a wind farm operator or to another entity that operates or owns the wind farm. Accordingly, an economic benefit of the wind turbines and the wind farm may be undesirably reduced as a result of such acoustic emission penalties.

### BRIEF DESCRIPTION OF THE INVENTION

In one embodiment, a control system for a wind turbine configured to generate an acoustic emission during operation is provided that includes a communication device. The communication device is configured to receive at least one penalty notification identifying a penalty to be assessed based on the acoustic emission generated. The control system also includes a processor coupled to the communication device. The processor is configured to calculate an acoustic emission level to be generated by the wind turbine based on the penalty and based on at least one of a power generated by the wind turbine and an economic value attributed to the wind turbine, and adjust at least one characteristic of the wind turbine to cause the wind turbine to operate at the calculated acoustic emission level.

In another embodiment, a wind farm is provided that includes at least one acoustic receptor configured to measure an acoustic emission generated within the wind farm and generate a penalty notification identifying a penalty to be assessed based on the measured acoustic emission. The wind farm also includes a plurality of wind turbines, wherein a first wind turbine of the plurality of wind turbines includes a communication device configured to receive the penalty notification and a processor coupled to the communication device. The processor is configured to calculate an acoustic emission level to be generated by the first wind turbine based on the penalty and based on at least one of a power generated by the first wind turbine and an economic value attributed to the first wind turbine and adjust at least one characteristic of the first wind turbine to cause the calculated acoustic emission level to be generated by the first wind turbine.

In yet another embodiment, a method of optimizing the operation of at least one wind turbine is provided that includes receiving at least one penalty notification identifying an assessed penalty based on an acoustic emission generated by the at least one wind turbine. The method also includes calculating an acoustic emission level to be generated by the at least one wind turbine based on the penalty and based on at least one of a power generated by the at least one wind turbine and an economic value attributed to the at least one wind turbine, and adjusting at least one characteristic of the at least one wind turbine to cause the calculated acoustic emission level to be generated by the at least one wind turbine.

### BRIEF DESCRIPTION OF THE DRAWINGS

FIG. 1 is a perspective view of an exemplary wind turbine.

FIG. 2 is a partial sectional view of an exemplary nacelle suitable for use with the wind turbine shown in FIG. 1.

FIG. 3 is a block diagram of an exemplary turbine control system suitable for use with the wind turbine shown in FIG. 1.

FIG. 4 is a schematic view of an exemplary wind farm that may include the wind turbine shown in FIG. 1.

FIG. 5 is a flow diagram of an exemplary method of optimizing an operation of at least one wind turbine suitable for use with the wind turbine shown in FIG. 1 and/or within the wind farm shown in FIG. 4.

FIG. 6 is a flow diagram of another exemplary method of optimizing an operation of at least one wind turbine suitable for use with the wind turbine shown in FIG. 1 and/or within the wind farm shown in FIG. 4.

### DETAILED DESCRIPTION OF THE INVENTION

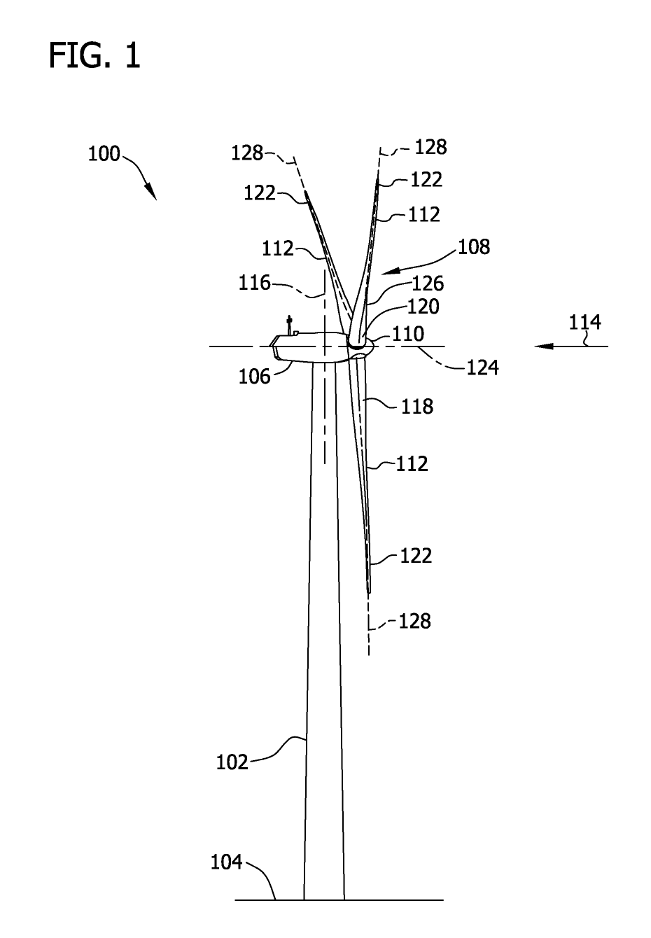

FIG. 1 is a schematic view of an exemplary wind turbine 100. In the exemplary embodiment, wind turbine 100 is a horizontal-axis wind turbine. Alternatively, wind turbine 100 may be a vertical-axis wind turbine. In the exemplary embodiment, wind turbine 100 includes a tower 102 extending from and coupled to a supporting surface 104. Tower 102 may be coupled to surface 104 with anchor bolts or with a foundation mounting piece (neither shown), for example. A nacelle 106 is coupled to tower 102, and a rotor 108 is coupled to nacelle 106. Rotor 108 includes a rotatable hub 110 and a plurality of rotor blades 112 coupled to hub 110. In the exemplary embodiment, rotor 108 includes three rotor blades 112. Alternatively, rotor 108 may have any suitable number of rotor blades 112 that enables wind turbine 100 to function as described herein. Tower 102 may have any suitable height and/or construction that enables wind turbine 100 to function as described herein.

Rotor blades 112 are spaced about hub 110 to facilitate rotating rotor 108, thereby transferring kinetic energy from wind 114 into usable mechanical energy, and subsequently, electrical energy. Rotor 108 and nacelle 106 are rotated about tower 102 on a yaw axis 116 to control a perspective of rotor blades 112 with respect to a direction of wind 114. Rotor blades 112 are mated to hub 110 by coupling a rotor blade root portion 118 to hub 110 at a plurality of load transfer regions 120. Load transfer regions 120 each have a hub load transfer region and a rotor blade load transfer region (both not shown in FIG. 1). Loads induced to rotor blades 112 are transferred to hub 110 through load transfer regions 120. Each rotor blade 112 also includes a rotor blade tip portion 122.

In the exemplary embodiment, rotor blades 112 have a length of between approximately 30 meters (m) (99 feet (ft)) and approximately 120 m (394 ft). Alternatively, rotor blades 112 may have any suitable length that enables wind turbine 100 to function as described herein. For example, rotor blades 112 may have a suitable length less than 30 m or greater than 120 m. As wind 114 contacts rotor blade 112, lift forces are induced to rotor blade 112 and rotation of rotor 108 about an axis of rotation 124 is induced as rotor blade tip portion 122 is accelerated.

A pitch angle (not shown) of rotor blades 112, i.e., an angle that determines the perspective of rotor blade 112 with respect to the direction of wind 114, may be changed by a pitch assembly (not shown in FIG. 1). More specifically, increasing a pitch angle of rotor blade 112 decreases an amount of rotor blade surface area 126 exposed to wind 114 and, conversely, decreasing a pitch angle of rotor blade 112 increases an amount of rotor blade surface area 126 exposed to wind 114. The pitch angles of rotor blades 112 are adjusted about a pitch axis 128 at each rotor blade 112. In the exemplary embodiment, the pitch angles of rotor blades 112 are controlled individually.

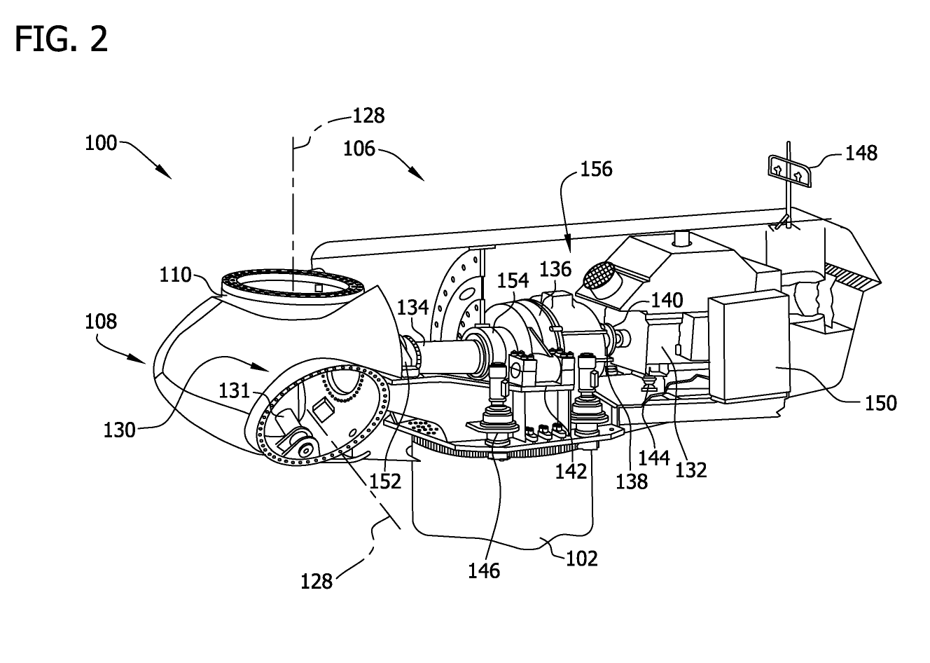

FIG. 2 is a partial sectional view of nacelle 106 of exemplary wind turbine 100 (shown in FIG. 1). Various components of wind turbine 100 are housed in nacelle 106. In the exemplary embodiment, nacelle 106 includes three pitch assemblies 130. Each pitch assembly 130 is coupled to an associated rotor blade 112 (shown in FIG. 1), and modulates a pitch of an associated rotor blade 112 about pitch axis 128. Only one of three pitch assemblies 130 is shown in FIG. 2. In the exemplary embodiment, each pitch assembly 130 includes at least one pitch drive motor 131.

As shown in FIG. 2, rotor 108 is rotatably coupled to an electric generator 132 positioned within nacelle 106 by a rotor shaft 134 (sometimes referred to as either a main shaft or a low speed shaft), a gearbox 136, a high speed shaft 138, and a coupling 140. Rotation of rotor shaft 134 rotatably drives gearbox 136 that subsequently drives high speed shaft 138. High speed shaft 138 rotatably drives generator 132 by coupling 140 and rotation of high speed shaft 138 facilitates production of electrical power by generator 132. Gearbox 136 is supported by a support 142 and generator 132 is supported by a support 144. In the exemplary embodiment, gearbox 136 utilizes a dual path geometry to drive high speed shaft 138. Alternatively, rotor shaft 134 is coupled directly to generator 132 by coupling 140.

Nacelle 106 also includes a yaw drive mechanism 146 that rotates nacelle 106 and rotor 108 about yaw axis 116 (shown in FIG. 1) to control the perspective of rotor blades 112 with respect to the direction of wind 114. Nacelle 106 also includes at least one meteorological mast 148 that includes a wind vane and anemometer (neither shown in FIG. 2). In one embodiment, meteorological mast 148 provides information, including wind direction and/or wind speed, to a turbine control system 150. In the exemplary embodiment, turbine control system 150 executes a SCADA (Supervisory, Control and Data Acquisition) program.

Pitch assembly 130 is operatively coupled to turbine control system 150. In the exemplary embodiment, nacelle 106 also includes a forward support bearing 152 and an aft support bearing 154. Forward support bearing 152 and aft support bearing 154 facilitate radial support and alignment of rotor shaft 134. Forward support bearing 152 is coupled to rotor shaft 134 near hub 110. Aft support bearing 154 is positioned on rotor shaft 134 near gearbox 136 and/or generator 132. Nacelle 106 may include any number of support bearings that enable wind turbine 100 to function as disclosed herein. Rotor shaft 134, generator 132, gearbox 136, high speed shaft 138, coupling 140, and any associated fastening, support, and/or securing device including, but not limited to, support 142, support 144, forward support bearing 152, and aft support bearing 154, are sometimes referred to as a drive train 156.

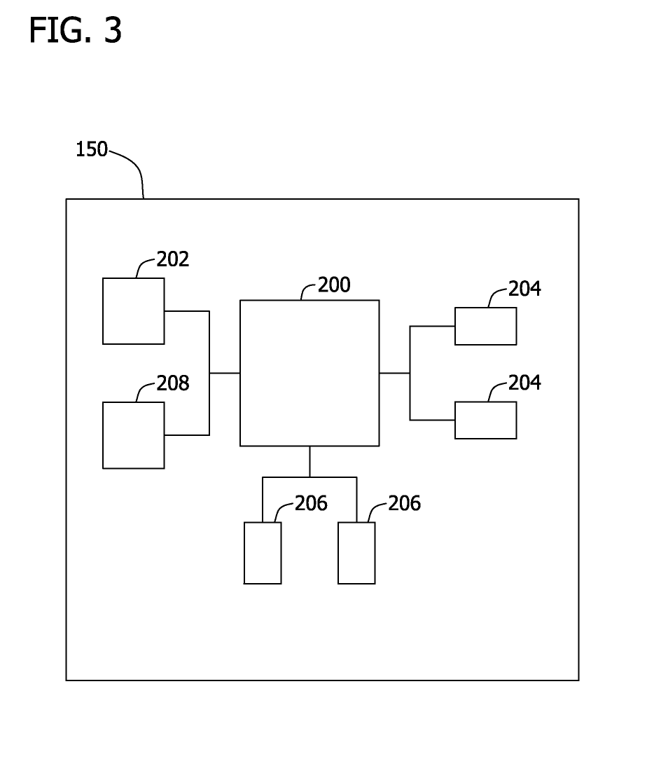

FIG. 3 is a block diagram of an exemplary turbine control system 150 that may be used with wind turbine 100 (shown in FIG. 1). In the exemplary embodiment, turbine control system 150 includes a processor 200 operatively coupled to a memory device 202, to at least one sensor 204, to at least one actuator 206, and to at least one communication device 208.

In the exemplary embodiment, processor 200 includes any suitable programmable circuit including one or more systems and microcontrollers, microprocessors, reduced instruction set circuits (RISC), application specific integrated circuits (ASIC), programmable logic circuits (PLC), field programmable gate arrays (FPGA), and any other circuit capable of executing the functions described herein. The above examples are exemplary only, and thus are not intended to limit in any way the definition and/or meaning of the term “processor.”

Memory device 202 includes a computer readable medium, such as, without limitation, random access memory (RAM), flash memory, a hard disk drive, a solid state drive, a diskette, and/or a flash drive. Alternatively, memory device 202 may include any suitable computer readable medium that enables turbine control system 150 to function as described herein. Memory device 202 stores and transfers information and instructions to be executed by processor 200.

In the exemplary embodiment, sensors 204 include, for example, one or more of the following: a voltage sensor, a current sensor, a wind speed sensor, a wind direction sensor, an air density sensor, a temperature sensor, an accelerometer, and/or any suitable sensor. Sensors 204 provide measurements of one or more operating conditions of wind turbine 100. In the exemplary embodiment, the measured operating conditions of wind turbine 100 include, without limitation, a generated power, a generated torque, a rotational speed of rotor 108 (shown in FIG. 1), a mechanical loading of one or more components of wind turbine 100, an air density, an altitude, a wind speed, a wind direction, an ambient temperature, and/or any suitable condition at or within wind turbine 100.

Communication device 208, in the exemplary embodiment, includes a wireless receiver and a wireless transmitter (neither shown) that receive and transmit data from and to one or more devices. Such devices may include, but are not limited to only including, other wind turbines 100, acoustic receptors (not shown in FIG. 3), computer systems such as a wind farm server (not shown), and/or any other device that enables turbine control system 150 to function as described herein. Additionally or alternatively, communication device 208 receives and/or transmits data from and/or to other devices through one or more data cables or other conductors.

In the exemplary embodiment, processor 200 receives data from communication device 208 and/or sensors 204 and operates actuators 206 based on the received data to adjust one or more components and/or characteristics of wind turbine 100. For example, actuators 206 include and/or are incorporated within one or more pitch drive motors 131 (shown in FIG. 2), yaw drive mechanism 146 (shown in FIG. 2), and/or any other component that enables wind turbine 100 to operate as described herein. Accordingly, for example, actuators 206 adjust a pitch angle of one or more rotor blades 112 and/or a yaw angle of nacelle 106 (both shown in FIG. 1) to change a rotational speed of rotor 108 and/or to change an amount of power generated by wind turbine 100.

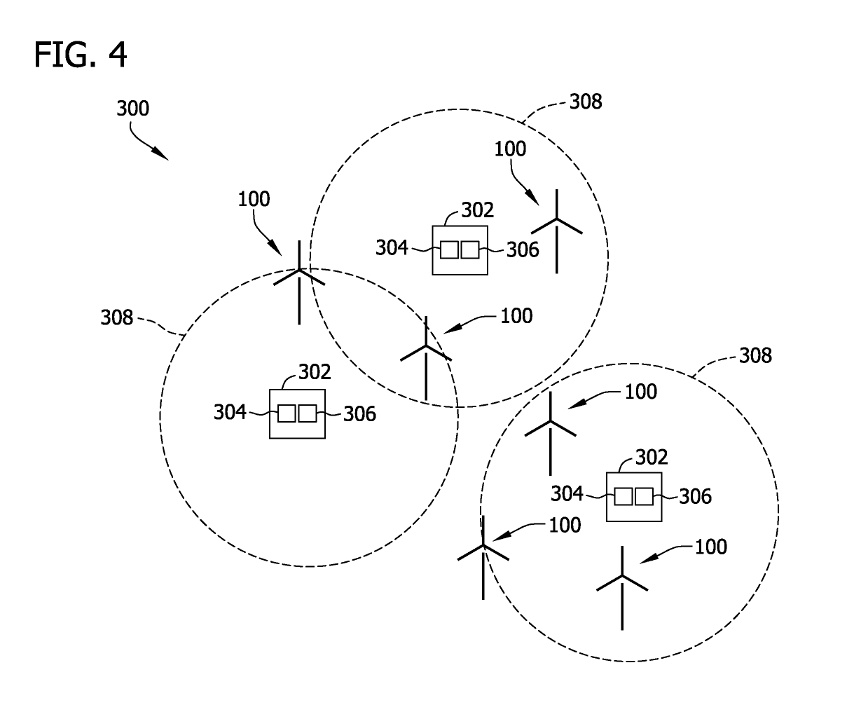

FIG. 4 is a schematic view of an exemplary wind farm 300. In the exemplary embodiment, wind farm 300 includes a plurality of wind turbines 100 and at least one acoustic receptor 302. As described above, each wind turbine 100 includes a turbine control system 150 (shown in FIG. 2) that communicates with acoustic receptors 302 and/or other wind turbines 100 (i.e., with turbine control system 150 of other wind turbines 100).

Each acoustic receptor 302, in the exemplary embodiment, includes an acoustic sensor 304 and a communication device 306 that includes a wireless transmitter and/or a wireless receiver (neither shown). Acoustic sensors 304 measure an amount of acoustic emissions (i.e., an amplitude of sound waves) received by acoustic receptor 302. Such acoustic emissions may be generated by wind turbines 100 and/or by any other source positioned within a detection zone 308 of acoustic sensors 304. Moreover, in the exemplary embodiment, each acoustic receptor 302 filters out acoustic emissions received from sources other than wind turbines 100 such that only acoustic emissions generated by wind turbines 100 are stored and/or processed by acoustic receptor 302.

In the exemplary embodiment, detection zone 308 is an area centered about acoustic receptor 302 in which acoustic emissions generated within detection zone 308 are detected by acoustic sensor 304. Detection zones 308, in the exemplary embodiment, are determined for each acoustic receptor 302 during a wind farm installation and/or during any other suitable time period, and are stored within a lookup table or another data construct within a memory device (not shown) positioned within acoustic receptor 302. Moreover, in the exemplary embodiment, detection zones 308 are determined and/or are updated to encompass wind turbines 100 that generate acoustic emissions exceeding a minimum acoustic threshold. In one embodiment, detection zones 308 overlap such that a wind turbine 100 is positioned within detection zones 308 of a plurality of acoustic receptors 302.

In the exemplary embodiment, depending on a relative position of each acoustic receptor 302 and each wind turbine 100 within wind farm 300, each acoustic sensor 304 receives and/or measures acoustic emissions generated by a plurality of wind turbines 100. Acoustic receptors 302 compare the amplitudes of the received acoustic emissions from wind turbines 100 to a predetermined penalty threshold. In the exemplary embodiment, the penalty threshold is determined by a government, an organization, and/or any other entity. Moreover, the penalty threshold represents a level of acoustic emissions authorized to be generated and/or deemed to be acceptable within wind farm 300 and/or another suitable area without a penalty being assessed. In the exemplary embodiment, the penalty threshold is based on the amplitude of one or more acoustic emissions and/or based on an average or sustained level of acoustic emissions received over a predetermined period of time.

If the amplitudes of the received acoustic emissions exceed the penalty threshold, acoustic receptor 302 transmits a penalty notification to wind turbines 100. The penalty notification, in the exemplary embodiment, includes a penalty to be assessed to the operator of wind farm 300 and/or to any other suitable person. Moreover, in the exemplary embodiment, the penalty increases linearly or nonlinearly as the acoustic emission amplitudes increase above the penalty threshold. In an alternative embodiment, a penalty notification may be generated if prior acoustic emissions have exceeded the penalty threshold by a predetermined amount and/or for a predetermined amount of time, even if the current acoustic emissions are below the penalty threshold. In such an embodiment, a penalty may still be assessed, but the penalty amount may be reduced linearly or nonlinearly based on the amount of time that has elapsed since the penalty threshold has been exceeded, based on the amount that the acoustic emissions are below the penalty threshold, and/or based on any other suitable criteria. As such, the penalty and/or the penalty notification may be updated over time, such as continuously, periodically, and/or intermittently updated. Moreover, in one embodiment, the penalty threshold may be updated or modified during operation of wind farm 300 and/or wind turbine 100.

In the exemplary embodiment, the penalty is determined or calculated within acoustic receptor 302 based on the acoustic emissions received. Alternatively, acoustic receptor 302 may transmit signals representative of the amount of acoustic emissions received to any other system or device for use in determining or calculating the penalty to be assessed. As used herein in the exemplary embodiment, the term “penalty” refers to a monetary amount assessed as a result of acoustic emissions exceeding the penalty threshold. Alternatively, a “penalty” may be an amount of power generation that must be reduced by wind turbines 100 and/or wind farm 300 as a result of acoustic emissions exceeding the penalty threshold, and/or any other quantity that enables wind farm 300 to function as described herein. As described more fully herein in the exemplary embodiment, wind turbines 100 optimize a power generation and/or an acoustic emission generation based on the penalty notification received. Alternatively, wind turbines 100 optimize the power generation and/or the acoustic emission generation based on an expected penalty notification and/or based on a notification of a penalty expected to be assessed. As such, wind turbines 100 may receive a notification of a penalty expected to be assessed if a current level of acoustic emissions is maintained, and wind turbines 100 may adjust or optimize the power generation and/or acoustic emission generation to reduce and/or cause the expected penalty to be modified.

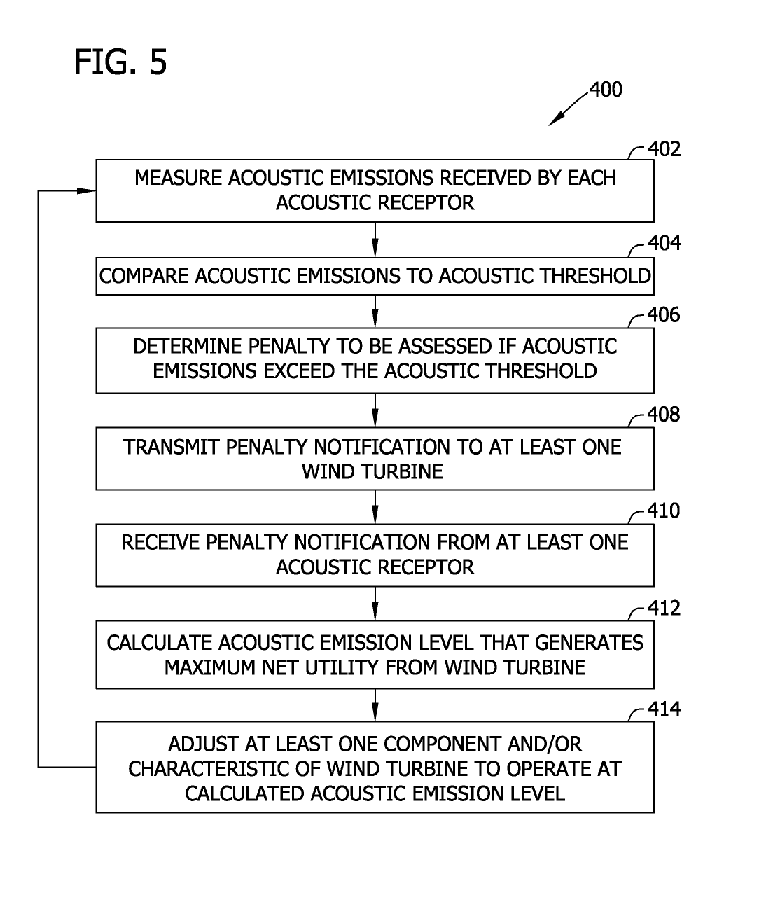

FIG. 5 is a flow diagram of an exemplary method 400 of optimizing an operation of at least one wind turbine, such as wind turbine 100 (shown in FIG. 1). In one embodiment, method 400 may be at least partially executed by a wind farm server or another computer system (not shown). In the exemplary embodiment, method 400 is at least partially executed by turbine control system 150 (shown in FIG. 2) of each wind turbine 100 within wind farm 300 (shown in FIG. 4). As such, in the exemplary embodiment, method 400 is at least partially executed as a distributed algorithm using turbine control systems 150 of a plurality of wind turbines 100 within wind farm 300.

In the exemplary embodiment, method 400 measures 402 acoustic emissions received by acoustic receptor 302 (shown in FIG. 4). For example, in the exemplary embodiment, each acoustic receptor 302 measures 402 acoustic emissions received from wind turbines 100 positioned within detection zone 308 (shown in FIG. 4). Alternatively, wind turbines 100 may measure acoustic emissions generated by each wind turbine 100 and transmit an acoustic emission measurement signal to acoustic receptor 302. Moreover, acoustic receptor 302 compares 404 the acoustic emissions to a predetermined acoustic threshold. If the acoustic emissions exceed the acoustic threshold, acoustic receptor 302 determines 406 a penalty to be assessed based on the acoustic emissions. In the exemplary embodiment, the penalty is updated if the acoustic emissions change.

In the exemplary embodiment, the penalty is an economic (i.e., monetary) amount assessed to wind turbines 100 within detection zone 308. Alternatively, the penalty may be represented in units of annual energy production (AEP) such that the penalty is accounted against the amount of power generated by each wind turbine 100 within detection zone 308 for use in determining the AEP of each wind turbine 100. Moreover, in the exemplary embodiment, each acoustic receptor 302 transmits 408 a penalty notification identifying the penalty to at least one wind turbine 100, such as each wind turbine 100 positioned within detection zone 308, if the acoustic emissions received by acoustic receptor 302 exceed the acoustic threshold.

Each wind turbine 100, in the exemplary embodiment, receives 410 a penalty notification from at least one acoustic receptor 302. Moreover, in the exemplary embodiment, each wind turbine 100 receives 410 one or more penalty notifications from each acoustic receptor 302 that has a detection zone 308 encompassing wind turbine 100. Each wind turbine 100 calculates 412 an acoustic emission level that generates a maximum net utility from wind turbine 100. As used herein, the term “net utility” refers to an amount of power generated by wind turbine 100 (e.g., the AEP of wind turbine 100) and/or an economic value attributed to wind turbine 100 based on the amount of power generated by wind turbine 100 (e.g., the AEP of wind turbine multiplied by a cost of energy). The net utility incorporates at least a portion of the penalty received 410 from acoustic receptors 302. More specifically, in the exemplary embodiment, wind turbine 100 determines and/or estimates the portion of each penalty attributable to the acoustic emissions generated by wind turbine 100, for example, by referencing an acoustic model stored within turbine control system 150. Alternatively, the acoustic model may be stored in, and/or updated by, one or more remote systems and/or may be based on measurements received from, and/or stored within, one or more systems. Accordingly, the net utility of each wind turbine 100 includes the portion of each penalty attributable to the acoustic emissions generated by wind turbine 100 subtracted from the overall AEP or economic value of wind turbine 100.

In the exemplary embodiment, each wind turbine 100 calculates the maximum net utility of wind turbine 100 by solving an optimization algorithm, such as Eq. 1:

$${f}_{i} ( {x}_{i} ) - {\sum }_{j = 1}^{M} {P}_{j} * {n}_{ij} ( {x}_{i} ) \qquad ( Eq . 1 )$$

wherein j is an index of an acoustic receptor 302, i is an index of a wind turbine 100 within detection zone 308 of acoustic receptor 302, and fᵢ (xᵢ) is the AEP or the economic value or output of wind turbine 100 as a function of the acoustic emission level xᵢ of wind turbine 100. Pⱼ is the penalty assessed by acoustic receptor 302, and nᵢⱼ (xᵢ) is the measured acoustic emission level at acoustic receptor 302 due to wind turbine 100 as a function of the acoustic emission xᵢ of wind turbine 100. In the exemplary embodiment, the acoustic emission level at acoustic receptor 302 due to wind turbine 100 is calculated and/or determined by referencing an acoustic emission model and/or a lookup table stored within turbine control system 150.

In the exemplary embodiment, turbine control system 150 solves the optimization algorithm by selecting a desired acoustic emission level xᵢ to be generated by wind turbine 100 that maximizes the resultant value of Eq. 1. More specifically, in the exemplary embodiment, turbine control system 150 selects an acoustic emission level xᵢ that maximizes a difference between the AEP or economic value or output of wind turbine 100 and the sum of the penalties Pⱼ attributable to wind turbine 100. Moreover, in the exemplary embodiment, turbine control system 150 solves the optimization algorithm using a gradient solver. Alternatively, turbine control system 150 solves the optimization algorithm using any suitable solver or method.

In the exemplary embodiment, turbine control system 150 adjusts 414 at least one component and/or characteristic of wind turbine 100 to operate at the calculated or desired acoustic emission level. More specifically, in the exemplary embodiment, turbine control system 150 operates actuators 206 (shown in FIG. 3) to adjust a pitch angle of rotor blades 112 and/or a yaw angle of nacelle 106 (both shown in FIG. 1) to increase or decrease the power generated by wind turbine 100. Because power generation is proportional to the acoustic emission level of wind turbine 100, increasing or decreasing the power generated by wind turbine 100 increases or decreases the acoustic emission level of wind turbine 100. After at least one component and/or characteristic of wind turbine 100 has been adjusted 414 to operate at the desired acoustic emission level, method 400 returns to measuring 402 the acoustic emissions received by each acoustic receptor 302.

In the exemplary embodiment, steps 402, 404, 406, and 408 of method 400 are executed by each acoustic receptor 302 within wind farm 300, and steps 410, 412, and 414 of method 400 are executed by each wind turbine 100 within wind farm 300. More specifically, in the exemplary embodiment, steps 410, 412, and 414 are executed by processor 200 of turbine control system 150 within each wind turbine 100 of wind farm 300. Alternatively, any step of method 400 may be executed by any suitable device or system that enables method 400 to function as described herein.

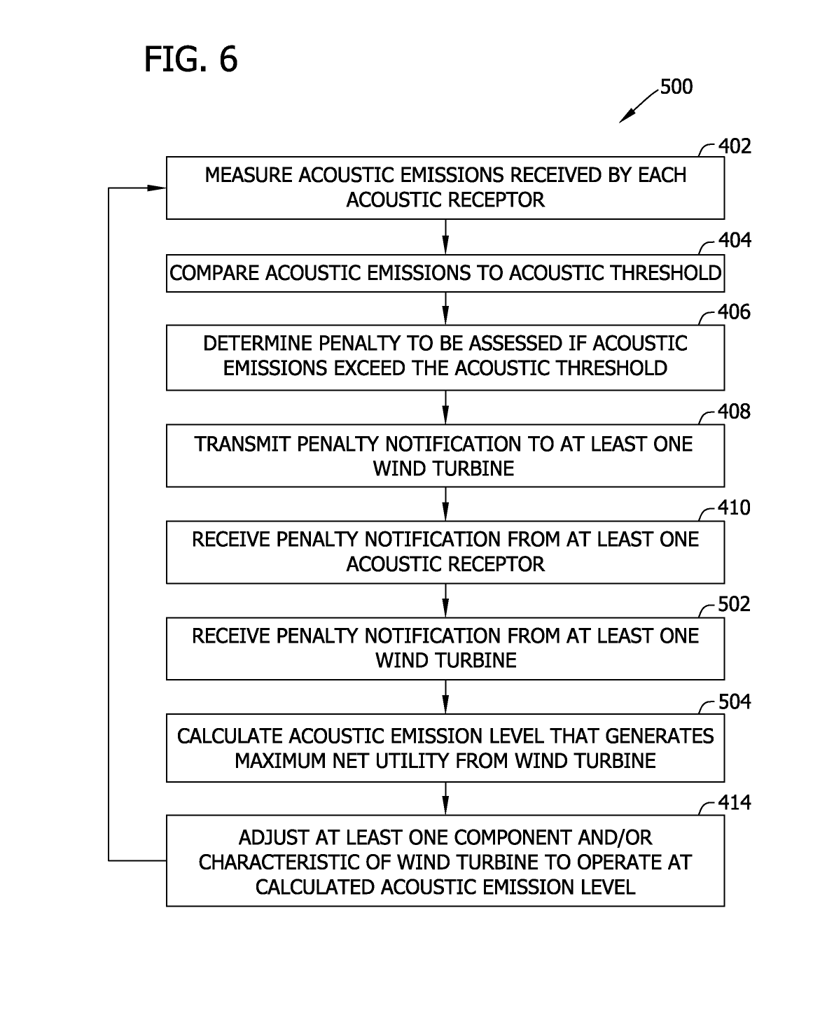

FIG. 6 is a flow diagram of an exemplary method 500 of optimizing an operation of a first wind turbine, such as wind turbine 100 (shown in FIG. 1). In the exemplary embodiment, method 500 is substantially similar to method 400 (shown in FIG. 5), and similar steps of method 500 are labeled with the same reference numerals as the steps of method 400. As such, method 500 includes steps 402, 404, 406, 408, and 410 as described more fully with respect to FIG. 5.

In the exemplary embodiment, method 500 is executed on a first wind turbine 100 of a plurality of wind turbines 100 within wind farm 300 (shown in FIG. 3). First wind turbine 100 is positioned upstream of a second wind turbine 100 such that second wind turbine 100 is positioned within a wake zone of first wind turbine 100. In the exemplary embodiment, a wake effect caused by first wind turbine 100 undesirably affects the loading induced to second wind turbine 100. As used herein, the term “wake effect” refers to a turbulence or loading induced to a downstream wind turbine 100 positioned within a wake zone of an upstream wind turbine 100. Moreover, as used herein, the term “wake zone” refers to an area of increased turbulence downstream from a wind turbine 100 that may be caused by an interaction of rotor blades 112 with wind flowing past wind turbine 100. It should be understood that as a wind direction and/or a rotation of rotor blades 112 changes, an orientation and/or a size of a wake zone may also change. Moreover, in certain conditions, a plurality of upstream wind turbines 100 may generate one or more wake zones that individually or together affect one or more downstream wind turbines 100.

First wind turbine 100, in the exemplary embodiment, receives 502 a load penalty notification from at least one wind turbine 100, such as second wind turbine 100. In one embodiment, first wind turbine 100 receives 502 a load penalty notification from a plurality of wind turbines 100 positioned within the wake zone of first wind turbine 100. As used herein, the term “load penalty” refers to a monetary amount and/or a power generation reduction amount assessed to and/or accounted against a wind turbine 100 as a result of a wake effect induced to wind turbine 100.

In the exemplary embodiment, an acoustic emission level is calculated 504 that generates a maximum net utility from first wind turbine 100. In the exemplary embodiment, the desired acoustic emission level of first wind turbine 100 is calculated 504 by solving an optimization algorithm, such as Eq. 2, to maximize the net utility of first wind turbine 100:

$${f}_{k} ( {x}_{k} ) + \frac{\partial {f}_{i}}{\partial {x}_{k}} * {x}_{k} - {Q}_{i} * \frac{\partial {L}_{i}}{\partial {x}_{k}} * {x}_{k} - {\sum }_{j = 1}^{M} {P}_{j} * {n}_{kj} ( {x}_{k} ) \qquad ( Eq . 2 )$$

wherein j is an index of an acoustic receptor 302, k is an index of first wind turbine 100 positioned within detection zone 308 of acoustic receptor 302, i is an index of second wind turbine 100 positioned within a wake zone of first wind turbine 100, and fₖ (xₖ) is the AEP or economic value or output of first wind turbine 100 as a function of the acoustic emission level xₖ of first wind turbine 100. The term ∂fᵢ/∂xₖ*xₖ represents the change in, or incremental AEP or economic value or output of second wind turbine 100 due to the wake effect of first wind turbine 100 as a function of the operation of first wind turbine 100 at the acoustic emission level xₖ. The term Qᵢ represents a load penalty communicated to first wind turbine 100 from second wind turbine 100, and Lᵢ represents the mechanical load on second wind turbine 100. As such, the term Qᵢ*∂Lᵢ/∂xₖ*xₖ represents the penalty due to the additional load induced to second wind turbine 100 as a result of the wake induced to second wind turbine 100 by first wind turbine 100.

The term Pⱼ represents the penalty assessed by acoustic receptor 302, and nᵢⱼ (xₖ) represents the measured acoustic emission level at acoustic receptor 302 due to first wind turbine 100 as a function of the acoustic emission xₖ of first wind turbine 100. In the exemplary embodiment, the acoustic emission level at acoustic receptor 302 due to first wind turbine 100 is calculated and/or determined by referencing an acoustic emission model and/or a lookup table stored within turbine control system 150. Accordingly, the term ΣPⱼ*nₖⱼ (xₖ) represents the sum of penalties due to acoustic emissions of first wind turbine 100 received by each acoustic receptor 302.

In the exemplary embodiment, first wind turbine 100 selects a value of xₖ that maximizes Eq. 2 and communicates the value to second wind turbine 100 for use in determining the optimal acoustic emission xᵢ of second wind turbine 100. More specifically, in the exemplary embodiment, first wind turbine 100 selects an acoustic emission level xₖ that maximizes a difference between the AEP or economic value or output of first wind turbine 100 and the sum of the load penalties Qᵢ and/or acoustic emission penalties Pⱼ attributable to first wind turbine 100. At least one component and/or characteristic of first wind turbine 100 is adjusted 414 to operate at the desired or calculated acoustic emission level in a similar manner as described above with reference to FIG. 5. In one embodiment, second wind turbine 100 updates the loading penalty based on the adjusted 414 operation of first wind turbine 100 (i.e., based on a change in the loading induced to second wind turbine 100 as a result of the operation of first wind turbine 100 at the adjusted acoustic emission level). After at least one component and/or characteristic of wind turbine 100 has been adjusted 414 to operate at the desired acoustic emission level, method 500 returns to measuring 402 the acoustic emissions received by each acoustic receptor 302.

In the exemplary embodiment, steps 402, 404, 406, and 408 of method 500 are executed by each acoustic receptor 302 within wind farm 300, and steps 410, 414 of method 500 are executed by each wind turbine 100 within wind farm 300. More specifically, in the exemplary embodiment, steps 410, 414, 502, and 504 are executed by processor 200 of turbine control system 150 within each wind turbine 100 of wind farm 300. Alternatively, any step of method 500 may be executed by any suitable device or system that enables method 500 to function as described herein.

While method 400 and method 500 are described herein as relating to wind turbines 100 and acoustic receptors 302 within wind farm 300, it should be recognized that method 400 and/or method 500 may also be executed among wind turbines 100 and/or acoustic receptors 302 of a plurality of wind farms 300.

Moreover, in one embodiment, method 400 and/or method 500 may optimize the operation of one or more wind turbines 100 based on an operational status of one or more wind turbines 100. For example, in one embodiment, an underperforming wind turbine 100 or a wind turbine 100 that has experienced a higher amount of loading and/or fatigue than other wind turbines 100 may be given a preference to operate at lower acoustic emission levels and/or power levels to extend an operational life of wind turbine 100 while determining the optimal acoustic emission levels, AEP, and/or economic output of wind turbine 100. Moreover, during a period of power curtailment, such as a period of power curtailment imposed by an electrical grid, a preference may be given to wind turbines 100 closer to acoustic receptors 302 to reduce the amount of acoustic emissions received by receptors 302. Furthermore, if one or more wind turbines 100 are shut down or disabled, for example, for maintenance purposes, acoustic emission levels and/or power levels of active wind turbines 100 may be increased to accommodate for the power loss of the disabled wind turbine 100, while still meeting acoustic emission constraints and/or optimizing the acoustic emission levels generated by the active wind turbines 100.

A technical effect of the systems and methods described herein includes at least one of: (a) receiving at least one penalty notification identifying an assessed penalty based on an acoustic emission generated by at least one wind turbine; (b) calculating an acoustic emission level to be generated by at least one wind turbine based on the penalty and based on at least one of a power generated by the at least one wind turbine and an economic value attributed to the at least one wind turbine; and (c) adjusting at least one characteristic of at least one wind turbine to cause the at least one wind turbine to be operated at a calculated acoustic emission level.

The above-described embodiments provide an efficient and robust method of optimizing the operation of a wind turbine. An acoustic receptor measures acoustic emissions received from one or more wind turbines and compares the acoustic emissions to a threshold. If the threshold is exceeded, a penalty is assessed and transmitted to the wind turbines within a detection zone of the acoustic receptor. Each wind turbine within the detection zone receives the penalty and calculates an optimal acoustic emission level to be generated by the wind turbine to maximize a net utility of the wind turbine. Moreover, additional loading induced to downstream wind turbines may be factored into the optimal acoustic emission level calculation to account for loading penalties associated with wake effects. Accordingly, the methods described herein enable the wind turbines within a wind farm to operate at an optimal economic output with respect to acoustic emission and/or loading penalties.

Exemplary embodiments of a control system, a wind farm, and methods of optimizing the operation of a wind turbine are described above in detail. The control system, wind farm, and methods are not limited to the specific embodiments described herein, but rather, components of the control system and/or wind farm and/or steps of the methods may be utilized independently and separately from other components and/or steps described herein. For example, the methods may also be used in combination with other power, fluid, and control systems, and is not limited to practice with only the wind farm and control system as described herein. Rather, the exemplary embodiment can be implemented and utilized in connection with many other power system applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A control system for a wind turbine, the wind turbine configured to generate an acoustic emission during operation, said control system comprising:
a communication device configured to receive at least one penalty notification identifying a penalty to be assessed based on the acoustic emission generated; and
a processor coupled to said communication device, said processor configured to:
calculate an acoustic emission level to be generated by the wind turbine based on the penalty and based on at least one of a power generated by the wind turbine and an economic value attributed to the wind turbine; and
adjust at least one characteristic of the wind turbine to cause the wind turbine to operate at the calculated acoustic emission level.

2. A control system in accordance with claim 1, wherein said processor is configured to calculate the acoustic emission level that maximizes a difference between the penalty and the at least one of a power generated by the wind turbine and an economic value attributed to the wind turbine.

3. A control system in accordance with claim 1, wherein said communication device is configured to receive at least one penalty notification from at least two of a plurality of acoustic receptors, each penalty notification identifying a penalty to be assessed based on the acoustic emission generated by the wind turbine.

4. A control system in accordance with claim 3, wherein said processor is configured to calculate an acoustic emission level to be generated by the wind turbine based on each penalty received and based on at least one of a power generated by the wind turbine and an economic value attributed to the wind turbine.

5. A control system in accordance with claim 1, wherein the wind turbine is a first wind turbine of a plurality of wind turbines, the penalty is based on an acoustic emission of each of the plurality of wind turbines, and wherein said processor identifies a portion of the penalty attributable to the acoustic emission generated by the first wind turbine.

6. A control system in accordance with claim 5, wherein said processor identifies a portion of the penalty attributable to the acoustic emission generated by the first wind turbine by referencing an acoustic model.

7. A control system in accordance with claim 1, wherein the wind turbine is a first wind turbine of a plurality of wind turbines, wherein said processor is configured to calculate an acoustic emission level to be generated by the wind turbine based on a loading induced to a second wind turbine of the plurality of wind turbines.

8. A wind farm comprising:
at least one acoustic receptor configured to:
measure an acoustic emission generated within said wind farm; and
generate a penalty notification identifying a penalty to be assessed based on the measured acoustic emission; and
a plurality of wind turbines, wherein a first wind turbine of said plurality of wind turbines comprises:
a communication device configured to receive the penalty notification; and
a processor coupled to said communication device, said processor configured to:
calculate an acoustic emission level to be generated by said first wind turbine based on the penalty and based on at least one of a power generated by said first wind turbine and an economic value attributed to said first wind turbine; and
adjust at least one characteristic of said first wind turbine to cause the calculated acoustic emission level to be generated by said first wind turbine.

9. A wind farm in accordance with claim 8, wherein said at least one acoustic receptor is configured to:
measure acoustic emissions from at least two of said plurality of wind turbines; and
generate at least one penalty notification identifying a penalty to be assessed based on the measured acoustic emissions.

10. A wind farm in accordance with claim 8, wherein said processor is configured to calculate the acoustic emission level that maximizes a difference between the penalty and the at least one of a power generated by said first wind turbine and an economic value attributed to said first wind turbine.

11. A wind farm in accordance with claim 8, wherein said at least one acoustic receptor comprises a plurality of acoustic receptors, wherein said communication device is configured to receive at least one penalty notification from at least two of said plurality of acoustic receptors, each penalty notification identifying a penalty assessed based on the acoustic emission generated within said wind farm.

12. A wind farm in accordance with claim 11, wherein said processor is configured to calculate an acoustic emission level to be generated by said first wind turbine based on each penalty received and based on at least one of a power generated by said first wind turbine and an economic value attributed to said first wind turbine.

13. A wind farm in accordance with claim 8, further comprising a second wind turbine, wherein said processor is configured to calculate an acoustic emission level to be generated by said first wind turbine based on a loading induced to said second wind turbine.

14. A wind farm in accordance with claim 13, wherein said processor is configured to calculate the acoustic emission level to be generated by said first wind turbine based on a loading induced to said second wind turbine by said first wind turbine.

15. A method of optimizing the operation of at least one wind turbine, said method comprising:
receiving at least one penalty notification identifying an assessed penalty based on an acoustic emission generated by the at least one wind turbine;
calculating an acoustic emission level to be generated by the at least one wind turbine based on the penalty and based on at least one of a power generated by the at least one wind turbine and an economic value attributed to the at least one wind turbine; and
adjusting at least one characteristic of the at least one wind turbine to cause the at least one wind turbine to be operated at the calculated acoustic emission level.

16. A method in accordance with claim 15, wherein said calculating an acoustic emission level comprises calculating an acoustic emission level that maximizes a difference between the penalty and the at least one of a power generated by the at least one wind turbine and an economic value attributed to the at least one wind turbine.

17. A method in accordance with claim 15, wherein said receiving at least one penalty notification comprises receiving at least one penalty notification from at least two of a plurality of acoustic receptors, each penalty notification identifying an assessed penalty based on the acoustic emission generated by the at least one wind turbine.

18. A method in accordance with claim 17, wherein said calculating an acoustic emission level comprises calculating an acoustic emission level to be generated by the at least one wind turbine based on each penalty received and based on at least one of a power generated by the at least one wind turbine and an economic value attributed to the at least one wind turbine.

19. A method in accordance with claim 15, wherein the at least one wind turbine is a first wind turbine of a plurality of wind turbines, the penalty is based on an acoustic emission of at least two of the plurality of wind turbines, said method further comprising identifying a portion of the penalty attributable to the acoustic emission generated by the first wind turbine.

20. A method in accordance with claim 15, wherein the at least one wind turbine is a first wind turbine of a plurality of wind turbines, wherein said calculating an acoustic emission level comprises calculating an acoustic emission level to be generated by the first wind turbine based on an amount of loading induced to a second wind turbine of the plurality of wind turbines.
